(19) United States
(12) Patent Application Publication
(10) Pub. No.: US 2024/0378091 A1
(43) Pub. Date: Nov. 14, 2024

(54) A computer-implemented or hardware-implemented method for processing data, a computer program product, a data processing system and a first control unit therefor

(71) Applicant: IntuiCell AB, Stockholm (SE)

(72) Inventors: Henrik Jörntell, Lund (SE); Linus Mårtensson, Malmö (SE)

(21) Appl. No.: 18/686,897

(22) PCT Filed: Aug. 26, 2022
(86) PCT No.: PCT/SE2022/050767

§ 371 Date: Feb. 27, 2024

(30) Foreign Application Priority Data
Sep. 3, 2021 (SE) 2151100-1

(51) Int. Cl. G06F 9/50

(52) U.S. Cl. CPC G06F 9/505; G06F 2209/5022; G06F 2209/508

(57) ABSTRACT

The disclosure relates to a computer-implemented or hardware-implemented method (200) for processing data, comprising: measuring (210), preferably by a first control module (110), a population activity of a processing unit (130) comprising a population, the processing unit (130) receiving a processing unit input (156) and producing a processing unit output (158); providing (220), preferably by the first control module (110), a first control signal (160), the first control signal (160) being based on a processing unit output (158) and based on the measured population activity of the processing unit (130); receiving (230), preferably by a second control module (120), a system input (152) comprising data to be processed; scaling (240), preferably by a second control module (120), the system input (152), based on the first control signal (160), thereby providing a scaled input to the processing unit (130) in the next time step; and utilizing (250) the processing unit output (158) as a system output (162). The disclosure further relates to a computer program product, a data processing system and a first control module.

### TECHNICAL FIELD

The present disclosure relates to a computer-implemented or hardware-implemented method for processing data as well as to a computer program product, a data processing system and a first control unit. More specifically, the disclosure relates to a computer-implemented or hardware-implemented method for a data processing system and a first control unit as defined in the introductory parts of the independent claims.

### BACKGROUND ART

Data processing is known from prior art. One technology utilized for data processing is Long short-term memory (LSTM). LSTM is an artificial recurrent neural network (RNN) architecture utilized in the field of deep learning. Unlike standard feedforward neural networks, LSTM has feedback connections. It can process not only single data points (such as images), but also entire sequences of data (such as speech or video). For example, LSTM is applicable to tasks such as unsegmented, connected handwriting recognition, speech recognition and anomaly detection in network traffic or IDSs (intrusion detection systems). Furthermore, an LSTM network with backpropagation can identify, e.g., when the output of a feed-forward, artificial neural network fails to converge to a desired solution, a parameter alteration that could increase the likelihood of converging to a desired solution. This parameter alteration may be to modify the time extent of the memorized data used to perform the data processing within the network. However, the process of altering the parameter may require extensive computational power to iteratively test the impact of any given alternative parameter setting, and still there is no guarantee that the most efficient solution of the problem in a given situation is found. As a matter of fact, this approach may even fail to solve the problem. Moreover, the existing solution may not work if the network is not feed-forward and/or if the network has no defined output layer.

US 2015/178617 A1 discloses a method of monitoring a neural network that includes monitoring activity of the neural network including performing an exception event based on a detected condition (based on the monitored activity). However, the method disclosed in US 2015/178617 A1 does not prevent overloading of an artificial neural network (ANN), instead it detects imbalance conditions in single neural nodes. Furthermore, there is no adjusting of the (system) input to the processing unit in US 2015/178617 A1.

US 2015/206049 A1 discloses a method for generating an event that includes monitoring a first neural network with a second neural network. Thus, US 2015/206049 A1 does not disclose any internal control of a single neural network. Furthermore, the method disclosed in US 2015/206049 A1 does not prevent overloading of an ANN. Moreover, there is no adjusting of the (system) input to the processing unit in US 2015/206049 A1.

Therefore, there is a need for alternative approaches of identifying when a processor, such as a network or an artificial neural network, does not converge to a desired solution. Furthermore, there is a need for approaches of identifying at what point in time of a time series (or where in the series of data) the explanation of data fails (leading to non-convergence). Preferably, such approaches provide or enable one or more of improved performance, higher reliability, increased efficiency, faster training, use of less computer power, use of less training data, use of less storage space, less complexity and/or use of less energy.

### SUMMARY

An object of the present disclosure is to mitigate, alleviate or eliminate one or more of the above-identified deficiencies and disadvantages in the prior art and solve at least the above-mentioned problem. Furthermore, in some embodiments, an objective is to provide an output, which information content follows the information content of the input of the system as closely as possible, possibly with a prediction component. Moreover, in some embodiments, an objective is to ensure that the input to the system does not overload and/or underload the system, i.e., that the capacity of the system is always sufficient.

According to a first aspect there is provided a computer-implemented or hardware-implemented method for processing data. The method comprises measuring, preferably by a first control module, a population activity of a processing unit comprising a population, the processing unit receiving a processing unit input and producing a processing unit output. Furthermore, the method comprises providing, preferably by the first control module, a first control signal, the first control signal being based on a processing unit output and based on the measured population activity of the processing unit. Moreover, the method comprises receiving, preferably by a second control module, a system input comprising data to be processed. The method comprises scaling, preferably by the second control module, the system input, based on the first control signal, thereby providing a scaled input to the processing unit in the next time step. Furthermore, the method comprises utilizing the processing unit output as a system output.

According to some embodiments, the method comprises checking if the measured population activity of the processing unit is larger than a first threshold/target population activity; and if the measured population activity of the processing unit is larger than the first threshold/target population activity, inhibiting the processing unit input based on the measured population activity of the processing unit.

According to some embodiments, the method comprises checking if the population activity of the processing unit is above a second threshold for a first amount of time steps; and if the population activity of the processing unit is above the second threshold for the first amount of time steps, resetting the processing unit and restarting the input, such as restarting the input sequence from the beginning.

According to some embodiments, the method comprises providing the processing unit output to an adjustment module; adjusting, by the adjustment module, the system input based on the processing unit output; and the step of receiving comprises receiving, by the adjustment module, the system input.

According to some embodiments, the system input is time-continuous data generated by one or more sensors, such as one or more cameras, one or more touch sensors, one or more sensors associated with a frequency band of an audio signal or one or more sensors related to a speaker, such as one or more microphones.

According to some embodiments, the method comprises converting, by a first conversion module, the system input to a first weight, the first weight preferably being positive; and optionally converting, by a second conversion module, the processing unit output to a second weight, the second weight preferably being negative. The first control signal is further based on the first and optionally the second weight(s).

According to a second aspect there is provided a computer program product comprising a non-transitory computer readable medium, having thereon a computer program comprising program instructions, the computer program being loadable into a data processing unit and configured to cause execution of the method of the first aspect or any of the above mentioned embodiments when the computer program is run by the data processing unit.

According to a third aspect there is provided a data processing system, configured to have a system input comprising data to be processed and a system output. The system comprises a processing unit configured to receive a processing unit input and to produce a processing unit output. The processing unit output is utilized as the system output. Furthermore, the system comprises a first control module configured to measure a population activity of the processing unit comprising a population and being configured to provide a first control signal. The first control signal is based on the processing unit output and the measured population activity of the processing unit. Moreover, the system comprises a second control module. The second control module is configured to receive the system input, configured to scale the system input based on the first control signal, and configured to provide the scaled system input as the processing unit input in the next time step. By scaling, e.g., reducing the gain of, the input to the processing unit, convergence is facilitated and/or activity saturation is avoided, thereby providing a more efficient processing of the data/information, especially during a learning/training phase. Furthermore, depending on the system capacity, infinitely long data series may be identified.

In some embodiments, the data processing system is an artificial neural network, wherein one or more of the processing unit, the first control module and the second control module comprises a group of nodes and a learning function, and wherein the system input the processing unit, the first control module and the second control module are multidimensional and implemented as arrays or matrices.

According to a fourth aspect there is provided a first control module. The first control module is connectable to a second control module and connectable to a processing unit. The first control module is configurable to measure a population activity of the processing unit, and configurable to provide a first control signal to the second control module, thereby enabling scaling of an input signal. The first control signal is based on a processing unit output and the measured population activity of the processing unit.

Effects and features of the second, third and fourth aspects are to a large extent analogous to those described above in connection with the first aspect and vice versa. Embodiments mentioned in relation to the first aspect are largely compatible with the second, third and fourth aspects and vice versa.

An advantage of some embodiments is that convergence is facilitated and/or activity saturation is avoided, thereby providing a more efficient processing of the data/information, especially during a learning/training phase.

Another advantage of some embodiments is that infinitely long data series may be identified.

Yet another advantage of some embodiments is a more efficient use of data.

A further advantage of some embodiments is that the risk of finding suboptimal solutions instead of optimal solutions is decreased.

Yet a further advantage of some embodiments is that a processor is able to decide, e.g., with an objective measure, when it is fully trained/learnt and thus training/learning may be stopped in advance, leading to more efficient/shorter/faster training/learning.

Another advantage of some embodiments is that a network may contain/comprise fewer nodes with better or maintained efficiency, thus providing a network with lower complexity.

A further advantage of some embodiments is that a proper/optimal length of data to be input to the processor is determined, thereby facilitating/enabling faster training/learning.

Yet a further advantage of some embodiments is that input-output systems in which one does not know how the connections between different blocks are, e.g., a black box system may be utilized, i.e., one does not need to know the internal structure of the system.

Other advantages of some of the embodiments are improved performance, higher reliability, increased efficiency, faster/shorter training/learning, use of less computer power, use of less training data, use of less storage space, less complexity and/or use of less energy.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic block diagram illustrating a data processing system according to some embodiments;

FIG. 2 is a flowchart illustrating method steps according to some embodiments;

FIG. 3 is a flowchart illustrating example steps performed by an apparatus for processing data according to some embodiments; and

FIG. 4 is a schematic drawing illustrating an example computer readable medium according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

The terms “node”, “cell” or “neural cell” may refer to a neuron, such as a neuron of an artificial neural network, another processing element, such as a processor, of a network of processing elements or a combination thereof.

The term “time step” is used below to describe an incremental change in time. E.g., one time step is defined as the period between an immediate previous time instance (or point in time) and the present time instance or the period between the present time instance and the immediately following/next time instance.

The term “population” is to be interpreted as a group or a set of nodes, cells, or neural cells.

The term “signal” is to be interpreted as a function that conveys information. The terms “activities” and “activity” are to be interpreted as equivalent to “signal”. However, the terms “activity levels” and “population activity” utilized below are to be interpreted as being indicative of a level of utilization of a node or a group of nodes. Population activity may be measured as a total activity of the nodes, as a mean or average value of the activity levels in a group of nodes or by subsampling the activity values of a group of nodes so as to select the activity value of one or more of the nodes in the group.

The term “time-continuous data” or “time-continuous signal” is to be interpreted as a signal of continuous amplitude and time, such as an analog signal.

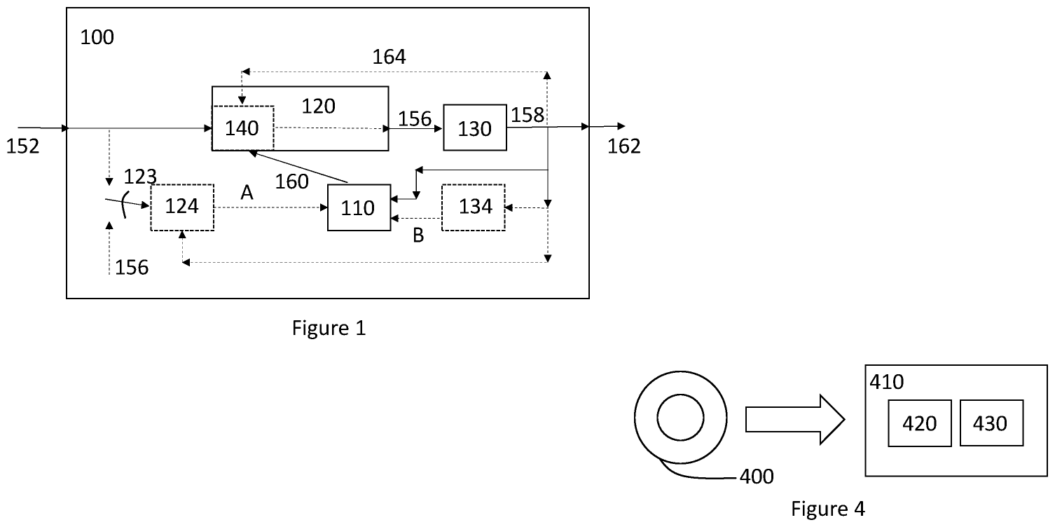

In the following, embodiments will be described where FIG. 1 is a schematic block diagram illustrating a data processing system 100 according to some embodiments. In some embodiments, the data processing system is a network. The network may comprise neural cells and/or other processing elements. Alternatively, the data processing system is a deep neural network, a deep belief network, a deep reinforcement learning system, a recurrent neural network, or a convolutional neural network. The data processing system 100 has or is configured to have or receive a system input 152. The system input 152 comprises data to be processed. The data may be multidimensional. E.g., a plurality of signals is provided in parallel. In some embodiments, the system input 152 comprises or consists of time-continuous data or continuous-time data, e.g., analog signals. Furthermore, the processing system 100 has or is configured to have/produce a system output 162. The data processing system 100 comprises a processing unit 130. The processing unit 130 comprises a population. The population is a set (or one or more subsets) of nodes. The processing unit 130 is configured to receive a processing unit input 156. Furthermore, the processing unit is configured to produce a processing unit output 158. In some embodiments, the processing unit output 158 comprises an activity level of each of a plurality of nodes, e.g., a subset of all the nodes, comprised in the processing unit 130. The processing unit output 158 is utilized as the system output 162. The data processing system 100 further comprises a first control module 110. The first control module 110 is configured to measure a population activity of the processing unit 130. In some embodiments, e.g., if the data processing system 100 comprises a network of nodes and the processing unit 130 comprises a subset of the nodes, the population activity of the processing unit 130 is calculated as the average or mean of the activity levels of all the nodes of the processing unit 130. Alternatively, the population activity is calculated as a total activity of the nodes or found by subsampling. In some embodiments, the data processing system 100 (or the first control module 110 thereof) comprises a population activity node for measuring the population activity of the processing unit 130. The population activity node receives information about the activity levels of each of the nodes of the processing unit 130 and calculates the population activity as a mean value of the activity levels of each of the nodes of the processing unit 130. Furthermore, the first control module 110 is configured to provide a first control signal 160. The first control signal 160 is based on the processing unit output 158 and the measured population activity of the processing unit 130. In some embodiments, the first control module 110 calculates the first control signal 160 based on the processing unit output 158 and the measured population activity of the processing unit 130. In some embodiments, the control signal 160 is based on a difference between the measured population activity of the processing unit 130 and a target population activity. In some embodiments, the first control signal 160 is compared to a threshold and if the first control signal 160 is below the threshold a signal being equal to 0 is generated and if the first control signal 160 is above the threshold a signal being equal to 1 is generated. Thus, in these embodiments, the scaled input to the processing unit 130 is either a zero signal (if the first control signal 160 is above the threshold) or a full system input 152 (if the first control signal 160 is below the threshold).

In some embodiments, the data processing system 100 comprises a first conversion module 124. The first conversion module 124 is configured to convert the system input 152 or the processing unit input 156 to a first gain A. The first conversion module 124 is connected to a switch 123 for selecting the system input 152 and/or the processing unit input 156. Moreover, the conversion to a first gain is based on the processing unit output 158. Preferably, the first gain A is positive. The first conversion module 124 is configured to send or otherwise communicate the first gain A to the first control module 110. In these embodiments, the first control signal 160 is further based on the first gain A. Furthermore, in some embodiments, the data processing system 100 comprises a second conversion module 134. The second conversion module 134 is configured to receive the processing unit output 158, to convert the processing unit output 158 to a second gain B and to send or otherwise communicate the second gain B to the first control module 110. Preferably, the second gain B is negative. In these embodiments, the first control signal 160 is based on the second gain B instead of being based on the processing unit output 158 directly. By utilizing the second gain B, the processing unit output 158 may be balanced before being utilized for control (via the first control signal). In some embodiments, the data processing system 100 comprises a second control module 120. The second control module 120 is configured to receive the system input 152. Furthermore, the second control module 120 is configured to scale the system input 152. The scaling is based on the first control signal 160. If the control signal 160 is based on a difference between the measured population activity of the processing unit 130 and a target population activity, the scaling may be gradual so that the larger the difference is, the more the system input 152 (or the gain thereof) is scaled, e.g., reduced. By scaling, e.g., reducing the gain of or reducing the amount of data of, the input to the processing unit 130, convergence is facilitated and/or activity saturation is avoided, thereby providing a more efficient processing of the data/information, especially during a learning phase. Furthermore, depending on the system capacity, infinitely long data series may be identified. Moreover, the first and second control modules 110, 120 may clarify the input data and thus enable the processing unit 130 to focus its resources to interpreting not yet explained input data, such as yet unexplained dimensions of the input data. The second control module 120 is configured to provide the scaled system input as the processing unit input 156 in a next time step. In some embodiments, the data processing system 100 or preferably the second control module 120 comprises an adjustment module 140. The adjustment module 140 is configured to receive the processing unit output 158 (indicated in FIG. 1 as 164). Furthermore, the adjustment module 140 is configured to adjust the system input 152 based on the processing unit output 158. In some embodiments, the adjustment module 140 is a summer, summation unit, subtractor, combiner or combining unit. In these embodiments, the processing unit output 158 is added to, subtracted from, or compared to the system input 152 to form an adjusted system input, e.g., the difference between the processing unit output 158 and the system input 152, and the adjusted system input is then utilized as the processing unit input 156 (scaled by the second control module 120). In some embodiments, the first and second control modules 110, 120 are configured to predict the next system input 152 to the processing unit 130 and the adjustment module 140 is configured to adjust the system input 152 with an adjustment/offset being equal to the difference between the predicted next system input 152 and the actual/real next system input 152. In some embodiments, the first control module 110 comprises the second control module 120 (or functions as a combined first and second control module). In some embodiments, the data processing system 100 and/or the processing unit 130 is in a learning mode/phase. Then if the activity level of a particular node/neural cell (of the processing unit 130) is below a threshold, this can be utilized to signal that the learning mode/phase can be limited or stopped for the particular node. If the activity level of the particular node/neural cell (of the processing unit 130) again rises above the threshold, learning mode can be reapplied. Furthermore, in the learning mode/phase, one or more of the blocks/modules 110, 120, 124, 130, 134, 140 in FIG. 1 may have its own learning function. Thus, the different blocks 110, 120, 124, 130, 134, 140 in FIG. 1 may be in the learning mode one at the time, all at the same time or one at the time sequentially after each other or only one of the blocks 110, 120, 124, 130, 134, 140 will be in the learning mode. As an example, only the first control module 110 may need to be in the learning mode. As another example, only the first control module 110 and the second control module 120 may need to be in the learning mode. As yet another example, only the first control module 110, the first conversion module 124, the second conversion module 134 and the adjustment module 140 may need to be in the learning mode. In some embodiments, the data processing system 100 is always in a learning mode, i.e., learning is performed when needed even when the system 100 is in an operating mode. Alternatively, once fully trained, the system 100 may switch to an operating mode. The system 100 may be considered to be fully trained e.g., when the population activity is below a population activity threshold. Thus, the system 100 may be considered to be not yet fully trained e.g., when the population activity is equal to or above the population activity threshold.

In one aspect, a first control module 110 is connectable or connected to a second control module 120. Furthermore, the first control module 110 is connectable or connected to a processing unit 130. The first control module 110 is configurable or configured to measure a population activity of the processing unit 130. Moreover, the first control module 110 is configurable or configured to provide a first control signal 160 to the second control module 120, thereby enabling scaling of an input signal 152. In some embodiments, in order to provide the first control signal 160, the first control module 110 calculates the control signal 160. The first control signal 160 is based on a processing unit output 158 and the measured population activity of the processing unit 130. Since the data processing system 100 comprises the first and the second control modules 110, 120, the data processing system 100 comprises an internal control mechanism and is thus able to exercise autonomous control or self-control.

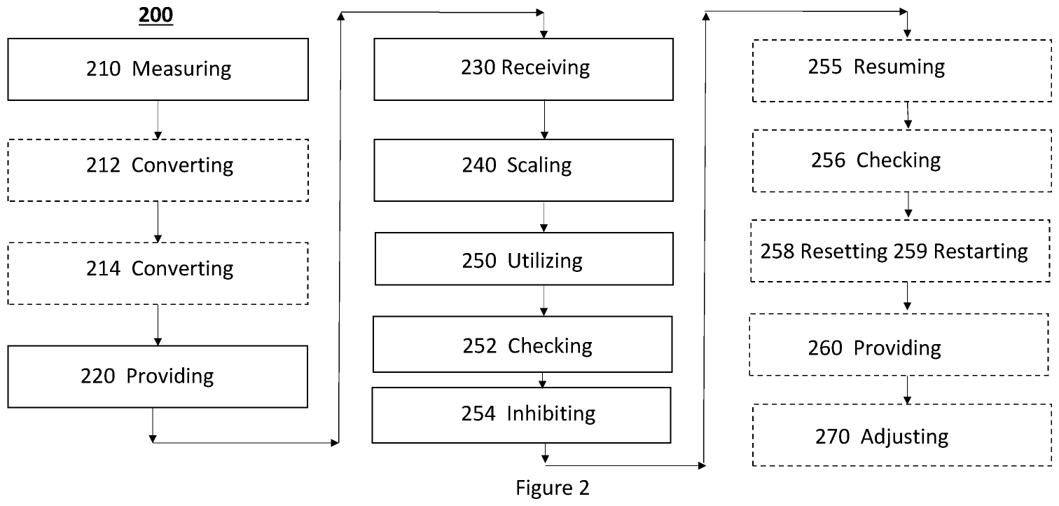

In some embodiments, the data processing system 100 is an artificial neural network. One or more of the first control module 110, the second control module 120 and the processing unit 130 comprises one or more groups of nodes. Furthermore, one or more of the first control module 110, the second control module 120 and the processing unit 130 comprise a learning function. Moreover, the system input 152, the system output 162, the first control module 110, the second control module 120, the processing unit 130 and optionally the first conversion module 124, the second conversion module 134 and the adjustment module 140 are multidimensional (have multidimensional input and/or output) and may therefore be implemented as arrays or matrices. An advantage of implementing each of the modules as multidimensional arrays is that the processing unit 130 can automatically focus its capacity to not yet explained dimensions of the input data, and thereby increase the precision (e.g., in explaining/estimating these dimensions). In some embodiments, specific nodes of the network may be grouped together to form a subgroup, an array, or a column in a matrix. The subgroups, arrays and/or matrices may additionally comprise information about a state, i.e., state variables describing the mathematical state of the dynamic system. The population activity may then be found by subsampling the activity levels of each group of nodes so as to select the activity value of one of the nodes in the group. Alternatively, the population activity may be found by calculating an average of the activity levels of the nodes of each group of nodes. Thus, the population activity may be multidimensional. Furthermore, in these embodiments, the processing unit output 158 comprises all of the activity levels of the nodes of the processing unit 130. In some embodiments, one or more of the first control module 110, the second control module 120, the processing unit 130, the first conversion module 124, the second conversion module 134 and the adjustment module 140 comprises a neural network. Thus, one or more of the blocks 110, 120, 124, 130, 134, 140 may comprise an input unit for receiving input signals, a scaling unit for scaling each of the input signals with a respective weight and optionally a summing unit configured to calculate a sum of the scaled input signals. Some of the weights, e.g., of the second conversion module 134, are in some embodiments 0, thus a sparse input is provided. Furthermore, each of the blocks 110, 120, 124, 130, 134, 140 may comprise a learning function. Moreover, by utilizing multidimensional modules (110, 120, 124, 130, 134 and/or 140), the data processing system/artificial neural network 100 is trained to distribute the (present) system input, e.g., sensor data, to one or more subgroup(s) or group(s) of nodes and depending on how well the (present) system input (e.g., sensor data) is processed/explained, i.e., how large the measured population activity is (e.g., in relation to the target population activity), inhibition of the system input (sensor data), e.g., to some or all subgroups or groups of nodes, is increased or decreased (as further explained below in connection with FIG. 2).

FIG. 2 is a flowchart illustrating example method steps according to some embodiments. FIG. 2 shows a computer-implemented or hardware-implemented method 200 for processing data. The method may be implemented in analog hardware/electronics circuit, in digital circuits, e.g., gates and flipflops, in mixed signal circuits, in software and in any combination thereof. The method comprises (at a present time step) measuring 210 a population activity of a processing unit 130. The processing unit 130 comprises a population. Furthermore, the processing unit 130 receives a processing unit input 156 and produces a processing unit output 158. Preferably the measuring 210 is performed by a first control module 110. Furthermore, the method comprises (at the present time step) providing 220 a first control signal 160. The first control signal is based on a processing unit output 158 and based on the measured population activity of the processing unit 130. Preferably the providing 220 is performed by the first control module 110. In some embodiments, the method comprises (at the present time step) converting 212, by a first conversion module 124, the system input 152 or the processing unit input 156 to a first gain A. The first gain A is preferably positive. Optionally the method comprises (at the present time step) converting 214, by a second conversion module 134, the processing unit output 158 to a second gain B. The second gain B is preferably negative. In these embodiments, the first control signal 160 is based on the first gain A and optionally on the second gain B. If the second gain B is utilized for the first control signal 160, the larger the processing unit output 158 is, the more the gain of the system input 152 is reduced (preferably by a second control module as explained below) before reaching the processing unit 130. Moreover, the method comprises (at the present time step) receiving 230 a system input 152 comprising data to be processed. Preferably the receiving 230 is performed by a second control module 120. The method comprises (at the present time step) scaling 240 the system input 152. Preferably the scaling 240 is performed by the second control module 120. Alternatively, the scaling 240 is performed by the first control module 110, e.g., if the first control module comprises the second control module 120. The scaling 240 is based on the first control signal 160. A scaled input is provided to the processing unit 130 in the next time step. Furthermore, the method comprises (at the present and/or next time step) utilizing 250 the processing unit output 158 as a system output 162. In some embodiments all the steps 210, 220, 230, 240,250 and optionally the steps 212, 214, 252, 254, 255, 256, 258, 259, 260, and 270 are repeated one or more times, e.g., in the next time step. In some embodiments, the method 200 continues or is repeated until all data to be processed has been processed. Alternatively, the method 200 continues or is repeated until the system 100 is fully trained. As yet another alternative, the method 200 continues or is repeated until the system is turned off. In some embodiments, the first control signal 160 has an initial value at the first time step/instance, such as 0 or 1. In some embodiments, the method comprises (at the present time step) checking 252 if the measured population activity of the processing unit 130 is larger than a first threshold. If the measured population activity of the processing unit 130 is larger than a first threshold, e.g., a target population activity, it is considered that activity saturation of the processing unit 130 is imminent. The first threshold may be adaptive, i.e., the first threshold may change over time. If the measured population activity of the processing unit 130 is larger than the first threshold, the method further comprises inhibiting 254 the processing unit input 156 based on the measured population activity of the processing unit 130. In some embodiments, the inhibiting 254 is based on a difference between the measured population activity of the processing unit 130 and the target population activity. The inhibiting 254 may be gradual so that the larger the measured population activity of the processing unit 130 is (or the larger the difference is), the more the processing unit input 156 is inhibited and thus the less data is available for the processing unit 130 to process. Thus, inhibiting 254 comprises reducing the data rate of the processing unit input 156. In some embodiments, inhibiting 254 (in order to reduce the data rate of the processing unit input 156) comprises inhibiting (or halting/stopping) the processing unit input 156 for a first time period and thereafter resuming 255 the processing unit input 156 (e.g., for a second time period, whereby the first and second time periods may be repeated). Alternatively, the inhibiting 254 is gradual so that the data rate of the processing unit input 156 is continuously regulated/controlled based on a difference between the measured population activity of the processing unit 130 and the target population activity. The regulation/control of the data rate may be performed by a controller, e.g., a PID controller, utilizing a control strategy based on a non-linear, such as exponential, or a linear equation having the difference between the measured population activity of the processing unit 130 and the target population activity as input. In some embodiments (when the inhibiting 254 is gradual), the data rate of the processing unit input 156 is continuously regulated/controlled only if the difference between the measured population activity of the processing unit 130 and the target population activity is higher than zero (0). If the difference is not higher than 0, then the data rate is not controlled. However, in other embodiments (when the inhibiting 254 is gradual), the data rate of the processing unit input 156 is continuously regulated/controlled even if the difference between the measured population activity of the processing unit 130 and the target population activity is equal or lower than 0. As an example, if the difference between the measured population activity of the processing unit 130 and the target population activity is lower than 0, then the data rate is increased and if the difference between the measured population activity of the processing unit 130 and the target population activity is higher than 0, then the data rate is decreased. By continuously controlling the data rate/through-put of the processing unit input 156, the ANN 100 is self-stabilizing and the data rate/through-put is improved or optimized. Furthermore, in some embodiments, the scaling 240 comprises the inhibiting 254. By inhibiting the processing unit 130 activity saturation may be avoided and/or the explanation/interpretation of the data is facilitated, thus facilitating learning. In some embodiments, the method comprises (at the present time step) checking 256 if the population activity of a processing unit 130 is above a second threshold for a first amount of time steps. If the population activity of a processing unit 130 is above a second threshold for a first amount of time steps, it is considered that convergence may never occur. If the population activity of the processing unit 130 is above the second threshold for the first amount of time steps, the method further comprises resetting 258 the processing unit 130 and thereafter restarting 259 the input. The input sequence may be restarted from the beginning. In these embodiments, convergence is facilitated. Thus, faster training/learning is enabled (e.g., if in the training/learning mode). In some embodiments, the second threshold is adaptive, i.e., the second threshold may change over time. Furthermore, in some embodiments, the resetting 258 and the restarting 259 is performed by a reset and restart module. Alternatively, the resetting 258 is performed by a reset module and the restarting 259 is performed by a restart module. In some embodiments, the method comprises providing 260 the processing unit output 158 to an adjustment module 140. The second control module 120 may comprise the adjustment module 140. The adjustment module 140 receives the system input 152 and adjusts 270 the system input 152 based on the processing unit output 158. In these embodiments, the step of receiving 230 comprises receiving, by the adjustment module 140, the system input 152.

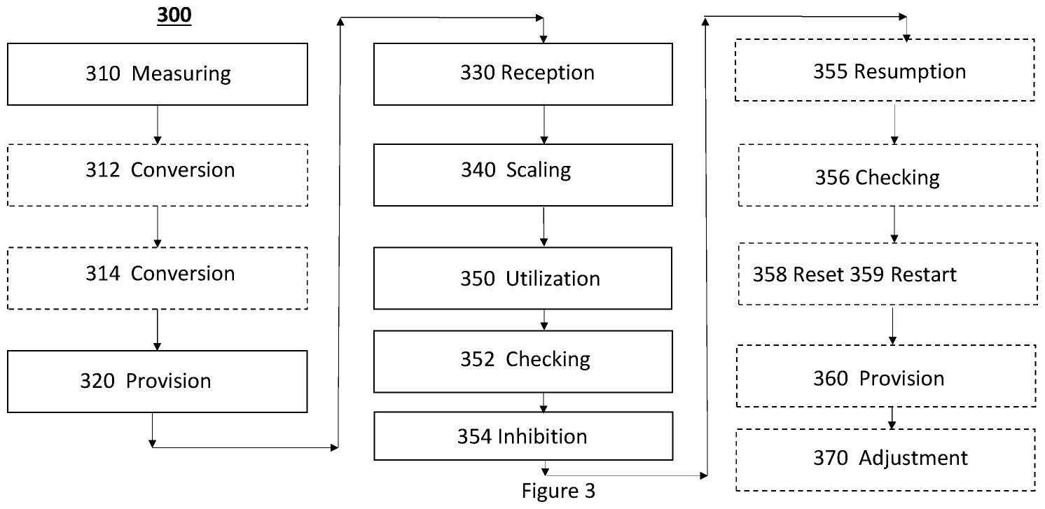

FIG. 3 is a flowchart illustrating example method steps implemented in an apparatus 300 for processing data. The apparatus 300 comprises controlling circuitry. The controlling circuitry may be one or more processors and/or networks. The controlling circuitry is configured to cause measuring 310 of a population activity of a processing unit 130, the processing unit 130 receiving a processing unit input 156 and producing a processing unit output 158. To this end, the controlling circuitry may be associated with (e.g., operatively connectable, or connected, to) a measurement unit (e.g., measurement circuitry or a measurer). Preferably a first control module 110 comprises the measurement unit. Furthermore, the controlling circuitry is configured to cause provision 320 of a first control signal 160, the first control signal 160 being based on a processing unit output 158 and based on the measured population activity of the processing unit 130. To this end, the controlling circuitry may be associated with (e.g., operatively connectable, or connected, to) a first provision unit (e.g., first providing circuitry or a first provider). Preferably the first control module 110 comprises the provision unit. In some embodiments, the controlling circuitry is configured to cause conversion 312 of the system input 152 or the processing unit input 156 to a first gain A. To this end, the controlling circuitry may be associated with (e.g., operatively connectable, or connected, to) a first conversion module 124 (e.g., first conversion circuitry or a first converter). The first gain A is preferably positive. The controlling circuitry may also be configured to cause conversion 314 of the processing unit output 158 to a second gain B. To this end, the controlling circuitry may be associated with (e.g., operatively connectable, or connected, to) a second conversion module 134 (e.g., second conversion circuitry or a second converter). The second gain B is preferably negative. In these embodiments, the first control signal 160 is based on the first gain A and optionally on the second gain B. Furthermore, the method comprises (at the present time step) provision 320 of a first control signal 160. The first control signal is based on a processing unit output 158 and based on the measured population activity of the processing unit 130. Preferably the provision 320 is performed by the first control module 110. Moreover, the controlling circuitry is configured to cause reception 330 of a system input 152 comprising data to be processed. To this end, the controlling circuitry may be associated with (e.g., operatively connectable, or connected, to) a reception unit (e.g., receiving circuitry or a receiver). Preferably the second control module 120 comprises the reception unit. Alternatively, the first control module 110 comprises the reception unit. The controlling circuitry is configured to cause scaling 340 of the system input 152 to provide an input to the processing unit 130 in the next time step. The scaling 340 is based on the first control signal 160. To this end, the controlling circuitry may be associated with (e.g., operatively connectable, or connected, to) a scaling unit (e.g., scaling circuitry or a scaler). Preferably the second control module 120 comprises the scaling unit. Alternatively, the first control module 110 comprises the scaling unit, e.g., if the first control module comprises the second control module 120. Furthermore, the controlling circuitry is configured to cause utilization 350 of the processing unit output 158 as a system output 162. To this end, the controlling circuitry may be associated with (e.g., operatively connectable, or connected, to) a utilization unit (e.g., utilization circuitry or a utilizer).

In some embodiments, the controlling circuitry is configured to cause checking 352 if the measured population activity of the processing unit 130 is larger than a first threshold. To this end, the controlling circuitry may be associated with (e.g., operatively connectable, or connected, to) a first checking unit (e.g., first checking circuitry or a first checker). In these embodiments, the controlling circuitry is configured to cause, if the measured population activity of the processing unit 130 is larger than the first threshold, inhibition 354 of the processing unit 130 for a first time period and thereafter resumption 355 of processing of data. To this end, the controlling circuitry may be associated with (e.g., operatively connectable, or connected, to) an inhibition and resumption unit (e.g., inhibiting and resuming circuitry or an inhibiter/resumer). In some embodiments, the inhibiter is comprised in the first control module 110, i.e., the first control module 110 comprises the inhibiter (not shown). Furthermore, in some embodiments, the inhibiter comprises a control unit or controller, such as a proportional-integral-derivative (PID) controller. In some embodiments, the controlling circuitry is configured to cause checking 356 if the population activity of a processing unit 130 is above a second threshold for a first amount of time steps. To this end, the controlling circuitry may be associated with (e.g., operatively connectable, or connected, to) a second checking unit (e.g., second checking circuitry or a second checker). In these embodiments, the controlling circuitry is configured to cause, if the population activity of the processing unit 130 is above the second threshold for the first amount of time steps, a reset 358 of the processing unit 130 and thereafter a restart 359 of the input to the processing unit 130. To this end, the controlling circuitry may be associated with (e.g., operatively connectable, or connected, to) a reset unit and a restart unit (e.g., reset/restart circuitry or a resetter/restarter). The input sequence may be restarted from the beginning. In some embodiments, the controlling circuitry is configured to cause provision 360 of the processing unit output 158 to an adjustment module 140. To this end, the controlling circuitry may be associated with (e.g., operatively connectable, or connected, to) a second provision unit (e.g., second providing circuitry or a second provider). The second control module 120 may comprise the adjustment module 140. In these embodiments, the controlling circuitry is configured to adjust the system input 152 based on the processing unit output 158. To this end, the controlling circuitry may be associated with (e.g., operatively connectable, or connected, to) an adjustment module. Furthermore, in these embodiments, the reception 330 comprises reception of the system input 152 at the adjustment module 140.

According to some embodiments, a computer program product comprises a non-transitory computer readable medium 400 such as, for example a universal serial bus (USB) memory, a plug-in card, an embedded drive, a digital versatile disc (DVD) or a read only memory (ROM). FIG. 4 illustrates an example computer readable medium in the form of a compact disc (CD) ROM 400. The computer readable medium has stored thereon, a computer program comprising program instructions. The computer program is loadable into a data processor (PROC) 420, which may, for example, be comprised in a computer or a computing device 410. When loaded into the data processing unit, the computer program may be stored in a memory (MEM) 430 associated with or comprised in the data-processing unit. According to some embodiments, the computer program may, when loaded into and run by the data processing unit, cause execution of method steps according to, for example, the method illustrated in FIG. 2, which is described herein.

In some embodiments, the data processing system 100 comprises one or more cells, each cell comprising an input gate, a forget gate and an output gate. Each cell remembers values over arbitrary time intervals and the gates regulate the flow of information into and out of the cell. Furthermore, in some embodiments, the data processing system 100 comprises feedback connections. The data processing system 100 may be an artificial recurrent neural network (RNN). In one embodiment, the data processing system 100 is an LSTM modified as described above. Alternatively, the data processing system 100 is a network of nodes, such as an attractor network. Furthermore, in some embodiments, the data processing system 100 is a module, attachable or attached to a feed-forward (neural/neuron) network. In these embodiments, the data processing system may prevent activity saturation in one or more individual nodes e.g., during the training/learning mode, thus improving the training/learning phase, such as shortening it or making it more efficient.

In some embodiments, the system input 152 is time-continuous data generated by one or more sensors. The sensors may be one or more cameras, such as digital cameras. Alternatively, the sensors may be one or more touch sensors, one or more sensors associated with a frequency band of an audio signal, or one or more sensors related to a speaker, such as one or more microphones. In some embodiments, the one or more sensors is a digital camera and the system input 152 is a time-continuous multidimensional input comprising time-continuous pixel values for each pixel of an image (of a time-continuous series of images). The pixel values represent intensity and/or color, i.e., all or some of the pixel values represent intensity and/or all or some of the pixel values represent color. The images may be captured by a camera, such as a digital camera. Furthermore, the data processing system 100 may be a network of nodes or neural cells, the processing unit 130 may comprise a plurality of the nodes and each of the nodes comprised in the processing unit 130 may be associated with a particular pixel. Thus, each particular node comprised in the processor may process the time-continuous pixel values (in the time-continuous series of images) of the particular pixel it is associated with.

In some embodiments, the one or more sensors are touch sensors and the system input 152 is a time-continuous multidimensional input comprising time-continuous touch event signals with force dependent values, e.g., values from 0 to 1. In some embodiments, the force dependent values are compared to a threshold to create a binary value, e.g., 0 or 1. Furthermore, the data processing system 100 may be a network of nodes or neural cells, the processing unit 130 may comprise a plurality of the nodes and each of the nodes comprised in the processing unit 130 may be associated with a particular touch sensor. Thus, each particular node comprised in the processor may process the time-continuous touch event signal of the particular touch sensor it is associated with.

In some embodiments, each sensor of the one or more sensors is associated with a different frequency band of an audio signal and the system input 152 is a time-continuous multidimensional input comprising time-continuous audio signals in different frequency bands. Each sensor reports an energy present in the associated frequency band. Furthermore, the data processing system 100 may be a network of nodes or neural cells, the processing unit 130 may comprise a plurality of the nodes and each of the nodes comprised in the processing unit 130 may be associated with a particular frequency band/sensor. Thus, each particular node comprised in the processor may process the time-continuous audio signal of the particular frequency band/sensor it is associated with.

### LIST OF EXAMPLES

1. A computer-implemented or hardware-implemented method (200) for processing data,
comprising:
measuring (210), preferably by a first control module (110), a population activity of a processing unit (130) comprising a population, the processing unit (130) receiving a processing unit input (156) and producing a processing unit output (158);
providing (220), preferably by the first control module (110), a first control signal (160), the first control signal (160) being based on a processing unit output (158) and based on the measured population activity of the processing unit (130);
receiving (230), preferably by a second control module (120), a system input (152) comprising data to be processed;
scaling (240), preferably by the second control module (120), the system input (152), based on the first control signal (160), thereby providing a scaled input to the processing unit (130) in the next time step; and
utilizing (250) the processing unit output (158) as a system output (162).

2. The method of example 1, further comprising:
checking (252) if the measured population activity of the processing unit (130) is larger than a first threshold; and
if the measured population activity of the processing unit (130) is larger than the first threshold, inhibiting (254) the processing unit input (156) based on the measured population activity of the processing unit (130).

3. The method of any of examples 1-2, further comprising:
checking (256) if the population activity of the processing unit (130) is above a second threshold for a first amount of time steps; and
if the population activity of the processing unit (130) is above the second threshold for the first amount of time steps, resetting (258) the processing unit (130) and restarting (259) the input, such as restarting the input sequence from the beginning.

4. The method of any of examples 1-3, further comprising:
providing (260) the processing unit output (158) to an adjustment module (140);
adjusting (270), by the adjustment module (140), the system input (152) based on the processing unit output (158); and
wherein the step of receiving (230) comprises receiving, by the adjustment module (140), the system input (152).

5. The method of any of examples 1-4, wherein the system input (152) is time-continuous data generated by one or more sensors, such as one or more cameras, one or more touch sensors, one or more sensors associated with a frequency band of an audio signal or one or more sensors related to a speaker, such as one or more microphones.

6. The method of any of examples 1-5, further comprising:
converting (212), by a first conversion module (124), the system input (152) to a first gain (A), the first gain (A) preferably being positive; and
optionally converting (214), by a second conversion module (134), the processing unit output (158) to a second gain (B), the second gain (B) preferably being negative; and
wherein the first control signal (160) is further based on the first and optionally the second gain(s).

7. A computer program product comprising a non-transitory computer readable medium (1000), having stored thereon a computer program comprising program instructions, the computer program being loadable into a data processing unit (1020) and configured to cause execution of the method according to any of examples 1-6 when the computer program is run by the data processing unit (1020).

8. A data processing system (100), configured to have a system input (152) comprising data to be processed and a system output (162), comprising:
a processing unit (130) comprising a population and being configured to receive a processing unit input (156) and to produce a processing unit output (158), the processing unit output (158) being utilized as the system output (162);
a first control module (110) configured to measure a population activity of the processing unit (130), and configured to provide a first control signal (160), the first control signal (160) being based on the processing unit output (158) and the measured population activity of the processing unit (130);
a second control module (120), configured to receive the system input (152), configured to scale the system input (152) based on the first control signal (160), and configured to provide the scaled system input as the processing unit input (156) in the next time step.

9. The data processing system of example 8, wherein the data processing system is an artificial neural network, wherein one or more of the processing unit (130), the first control module (110) and the second control module (120) comprises a group of nodes and a learning function, and wherein the system input (152), the processing unit (130), the first control module (110) and the second control module (120) are multidimensional and implemented as arrays or matrices.

10. A first control module (110), connectable to a second control module (120) and connectable to a processing unit (130), the first control module being configurable to measure a population activity of the processing unit (130), and configurable to provide a first control signal (160) to the second control module (120) thereby enabling scaling of an input signal (152), the first control signal (160) being based on a processing unit output (158) and the measured population activity of the processing unit (130).

The person skilled in the art realizes that the present disclosure is not limited to the preferred embodiments described above. The person skilled in the art further realizes that modifications and variations are possible within the scope of the appended claims. For example, signals from other sensors, such as aroma sensors or flavor sensors may be processed by the data processing system. Moreover, the data processing system described may equally well be utilized for unsegmented, connected handwriting recognition, speech recognition, speaker recognition and anomaly detection in network traffic or intrusion detection systems, IDSs. Additionally, variations to the disclosed embodiments can be understood and effected by the skilled person in practicing the claimed disclosure, from a study of the drawings, the disclosure, and the appended claims.

1. A computer-implemented method for managing a processing load on an artificial neural network configured to process data, the artificial neural network comprising a first control module, a second control module, a processing unit configured to produce processing unit output responsive to receiving processing unit input, wherein the processing unit comprises one or more nodes of the artificial neural network, and an inhibiter, the method comprising:
measuring, by the first control module, a population activity of the processing unit responsive to the processing unit receiving a processing unit input and producing a processing unit output, wherein the population activity of the processing unit is determined from activity levels of one or more nodes in a population of the processing unit;
providing, by the first control module, a first control signal, the first control signal being based on the processing unit output produced by the processing unit processing the processing unit input and based on the measured population activity of the processing unit;
receiving, by the second control module, a system input comprising data to be processed;
scaling, by the second control module, the system input, based on the first control signal, thereby providing a scaled input to the processing unit in a next time step;
utilizing the processing unit output as a system output;
checking if the measured population activity of the processing unit is larger than a target population activity;
wherein responsive to the measuring determining the measured population activity of the processing unit is larger than the target population activity, the method further comprises:
inhibiting, by the inhibiter, the processing unit input based on a difference between the measured population activity of the processing unit and the target population activity to manage the processing load on the artificial neural network.

2. The method of claim 1, wherein the inhibiting is gradual so that the larger the difference between the measured population activity of the processing unit and the target activity, the more the system input or the gain of the system input is scaled.

3. The method of claim 1, wherein the target population activity changes over time.

4. The method of claim 1, wherein the input comprises an input sequence, and the method further comprises:
checking if the population activity of the processing unit is above a second threshold for a first amount of time steps; and
responsive to the checking determining the population activity of the processing unit is above the second threshold for the first amount of time steps, resetting the processing unit and restarting the input sequence.

5. The method of claim 1, wherein the input comprises an input sequence, and the method further comprises:
checking if the population activity of the processing unit is above a second threshold for a first amount of time steps; and
responsive to the checking determining the population activity of the processing unit is above the second threshold for the first amount of time steps, resetting the processing unit and restarting the input sequence, wherein the second threshold changes over time.

6. The method of claim 1, further comprising:
providing the processing unit output to an adjustment module;
adjusting, by the adjustment module, the system input based on the processing unit output; and
wherein the step of receiving comprises receiving, by the adjustment module, the system input.

7. The method of claim 1, wherein the system input is time-continuous data generated by one or more sensors, wherein each sensor of the one or more sensors comprises a sensor selected from the group consisting of:
a camera;
a touch sensor;
a sensor associated with a frequency band of an audio signal;
a sensor related to a speaker; and
a microphone.

8. The method of claim 1, further comprising:
converting, by a first conversion module, the system input to a first gain A, the first gain A being positive; and
optionally, converting, by a second conversion module, the processing unit output to a second gain B, the second gain B being negative; and
wherein the first control signal is further based on the first gain A and optionally the second gain B.

9. The method of claim 1, further comprising:
repeating the steps of measuring, providing, receiving, scaling, utilizing, checking, inhibiting and optionally one or more of the steps of converting, converting, checking, resetting, restarting, providing, and adjusting until the artificial neural network system is fully trained.
wherein the artificial neural network system is fully trained when the population activity is below a population activity threshold.

10. The method of claim 1, further comprising:
repeating the steps of measuring, providing, receiving, scaling, utilizing, checking, inhibiting and optionally one or more of the steps of converting, converting, checking, resetting, restarting, providing, and adjusting until the system is fully trained,
wherein the system is fully trained when the measured population activity is below a population activity threshold.

11. (canceled)

12. An artificial neural network, configured to receive a system input comprising data to be processed and configured to produce a system output, the artificial neural network comprising:
a processing unit comprising a population of nodes and being configured to receive a processing unit input and to produce a processing unit output, wherein the population activity of the processing unit is determined from activity levels of nodes of the processing unit, the processing unit output being utilized as the system output;
a first control module configured to measure a population activity of the processing unit, and configured to provide a first control signal, the first control signal being based on the processing unit output and the measured population activity of the processing unit;
a second control module, configured to receive the system input, configured to scale the system input based on the first control signal, and configured to provide the scaled system input as the processing unit input in a next time step; and
an inhibiter configured to inhibit the processing unit input based on a difference between the measured population activity of the processing unit and a target population activity, thereby managing a processing load of the artificial neural network.

13. The artificial neural network of claim 12, wherein the inhibiter is configured to inhibit the processing unit input gradually.

14. The artificial neural network of claim 12, wherein one or more of the processing unit, the first control module and the second control module comprises a population of nodes and a learning function, and wherein the system input, the processing unit, the first control module and the second control module are multidimensional and implemented as arrays or matrices.

15. A first control module configured to manage a processing load of an artificial neural network system, connectable to a second control module and connectable to a processing unit comprising a population of data processing nodes of an artificial neural network, the first control module being configurable to measure a population activity of the processing unit, configurable to provide a first control signal to the second control module thereby enabling scaling of an input signal, the first control signal being based on a processing unit output and a measured population activity of processing nodes of the population of the processing unit, and the first control module being configurable to inhibit the processing unit input based on a difference between the measured population activity of the processing unit and a target population activity, thereby managing the processing load on the artificial neural network.

16. The method of claim 1, wherein the artificial neural network system performs learning when needed even when the artificial neural network is in an operating mode.

17. The method of claim 1, wherein the artificial neural network system switches from a learning mode to an operating mode once the population activity is below a population activity threshold, wherein in the learning mode the artificial neural network is trained to provide system output having an information content which follows an information content of input to the artificial neural network system as closely as possible.

18. The method of claim 1, wherein measuring a population activity of a group of nodes comprises measuring the total activity level of the group of nodes.

19. The method of claim 1, wherein measuring a population activity of a group of nodes comprises measuring an average or mean of the activity levels of the group of nodes.

20. The method of claim 1, wherein measuring a population activity of a group of nodes comprises subsampling the activity values of the group of nodes so as to select the activity value of one or more nodes in the group.

21. The method of claim 1, wherein managing the processing load on the artificial neural network prevents underloading and/or overloading of the processing unit.
